(19) United States
(12) Patent Application Publication
(10) Pub. No.: US 2003/0056413 A1
(43) Pub. Date: Mar. 27, 2003

(54) Display system

(76) Inventors: James A. Wiemer, Fox Point, WI (US); Richard P. Hornblad, Shorewood, WI (US)

Correspondence Address: FOLEY & LARDNER, 777 EAST WISCONSIN AVENUE, MILWAUKEE, WI, 53202, US

(21) Appl. No.: 10/227,153

(22) Filed: Aug. 23, 2002

Related U.S. Application Data
(60) Provisional application No. 60/314,856, filed on Aug. 24, 2001.

(51) Int. Cl. G09F 7/00

(52) U.S. Cl. 40/730; 40/605

(57) ABSTRACT

A display system for displaying graphics is disclosed. A display system may include a first frame configured to be coupled to the support surface, a first panel configured to be removably coupled to the first frame, and a first graphic component provided on the first panel. The display system may further include a second frame configured to be coupled to the support surface, a second panel configured to be removably coupled to the second frame, and a second graphic component provided on the second panel. The first graphic and the second graphic components are configured to provide a portion of the enlarged graphic

### CROSS-REFERENCE TO RELATED PATENT APPLICATIONS

The present application claims the benefit of priority as available under 35 U.S.C. §§119 and 120 of the following applications: U.S. Patent Application No. 60/314,856 (“DISPLAY SYSTEM”) filed Aug. 24, 2001 (the entire disclosure of this application is incorporated by reference); and U.S. patent application Ser. No. 09/692,559 (“MAGNETIC GRAPHICS DISPLAY”) filed Oct. 19, 2000 (the entire disclosure of this application is incorporated by reference).

### FIELD OF THE INVENTION

The present invention relates to a display system. The present inventions more specifically relate to modular and/or panel type display system for association with an existing surface (such as a wall) or frame.

### BACKGROUND OF THE INVENTION

It is known to provide for a panel system that may be used on various support surfaces such as walls, ceilings, floors, etc. Such panel systems do not realize certain advantageous features (and/or combinations of features).

It would be advantageous to provide a display system that provides modular panels having a variety of surface treatments such as graphics, finishes, color, materials, etc. It would further be advantageous to provide a display system that provides for the relatively quick and easy replacement of panel surface treatments, graphics, etc. It would further be advantageous to provide a display system that provides for the selective arrangement, updating and/or replacing of graphics, and/or single or multiple graphical images or panels. It would further be advantageous to provide a display system including panels that may be placed into existing grids or frames provided on walls. It would further be advantageous to provide a display system having individual panels with easily changeable or interchangeable graphics, that would replace existing panels with graphics.

It would be desirable to provide a display system or the like of a type disclosed in the present application that includes any one or more of these or other advantageous features.

### SUMMARY OF THE INVENTION

The present invention relates to a display system for providing an enlarged graphic on a support surface. The display system comprises a first frame configured to be coupled to the support surface, a first panel configured to be removably coupled to the first frame, and a first graphic component provided on the first panel. The display system further comprises a second frame configured to be coupled to the support surface, a second panel configured to be removably coupled to the second frame, and a second graphic component provided on the second panel. The first graphic and the second graphic components are configured to provide a portion of the enlarged graphic.

The present invention also relates to a method of providing a graphic using at least two panels, each panel having a portion of the graphic provided on a surface of the panel, and the graphic is to be provided on a support surface. The method comprises providing at least two frames on a support surface, and providing at least two panels configured to be magnetically coupled to the at least two frames. Each portion of the graphic provided on the surface of the at least two panels comprises a portion of the graphic.

The present invention further relates to a display system comprising a first frame, a first panel configured to be selectively attached and removed from the first frame, a first sheet, and a magnetic material provided between the first sheet and the first panel. The first sheet is configured to be selectively attached and removed from the first panel.

The present invention further relates to a method of repairing a display system having at least one frame and at least one panel connected to the at least one frame with a fastener. The method comprises removing the at least one panel, and providing a new panel in the frame. The new panel comprises a fastener configure to coact with the fastener of the frame, and a sheet magnetically coupled to the new panel.

The present invention further relates to a method of updating an enlarged graphic, the enlarged graphic being comprised of a plurality of individual sheets magnetically coupled to a plurality of individual bases. The method comprises removing the plurality of individual sheets from the plurality of individual bases, and providing a plurality of new individual sheets configured to magnetically couple to the plurality of individual bases.

The present invention further relates to a display system for providing a graphic on a support surface. The display system comprises a first frame coupled to the support surface, a first panel configured to be removably coupled to the first frame, a first graphic component provided on the first panel. The display system further comprises a second frame provided adjacent the first frame, a second panel configured to be removably coupled to the second frame, and a second graphic component provided on the second panel. The display system further comprises a link provided between the first frame and the second frame, wherein the link is configured to interconnect the first frame and the second frame.

### BRIEF DESCRIPTION OF THE DRAWINGS

FIG. 1 is a perspective view of a display system according to an exemplary embodiment.

FIG. 2 is an exploded perspective view of a frame provided with magnetic material for use with a display system according to an exemplary embodiment.

FIG. 3 is a front perspective view of a frame for use with a display system according to an exemplary embodiment.

FIG. 4 is a rear perspective view of a frame for use with a display system according to an exemplary embodiment.

FIG. 5 is a rear perspective view of a panel for use with a display system according to an exemplary embodiment.

FIG. 6 is a perspective view of a link for use with a display system according to an exemplary embodiment.

FIG. 7 is a perspective view of a link for use with a display system according to an exemplary embodiment.

FIG. 8 is a perspective view of a display system according to an alternative embodiment.

FIG. 9 is a front perspective view of a frame for use with a display system according to an alternative embodiment.

FIG. 10 is a rear perspective view of a frame for use with a display system according to an alternative embodiment.

FIG. 11 is a rear perspective view of a panel for use with a display system according to an alternative embodiment.

### DETAILED DESCRIPTION OF THE PREFERRED EMBODIMENTS

As shown in the FIGURES, a display system configured to present a graphic, visual effect or other information (e.g., text, messages, visual image(s), text/pictorial combinations, etc.) may be provided to allow for the presentation and/or display of a large or enlarged graphic on a variety of structures or surfaces such as walls, ceilings, floors, non-vertical or non-horizontal structures, supports, etc. It may be desirable to present a large “composite” graphic (i.e., a large or enlarged overall graphic that has been broken up into several components, portions, pieces, etc.). However, it may not be convenient to produce a large image in a single printing step or process. The display system shown in the exemplary embodiments allows for the presentation and/or display of large or enlarged graphics (as well as individual graphics) individually or comprised of segments or components. The display system may be used on walls to provide an overall larger image, graphic, or similar visual effect than the size of each panel used in the display system.

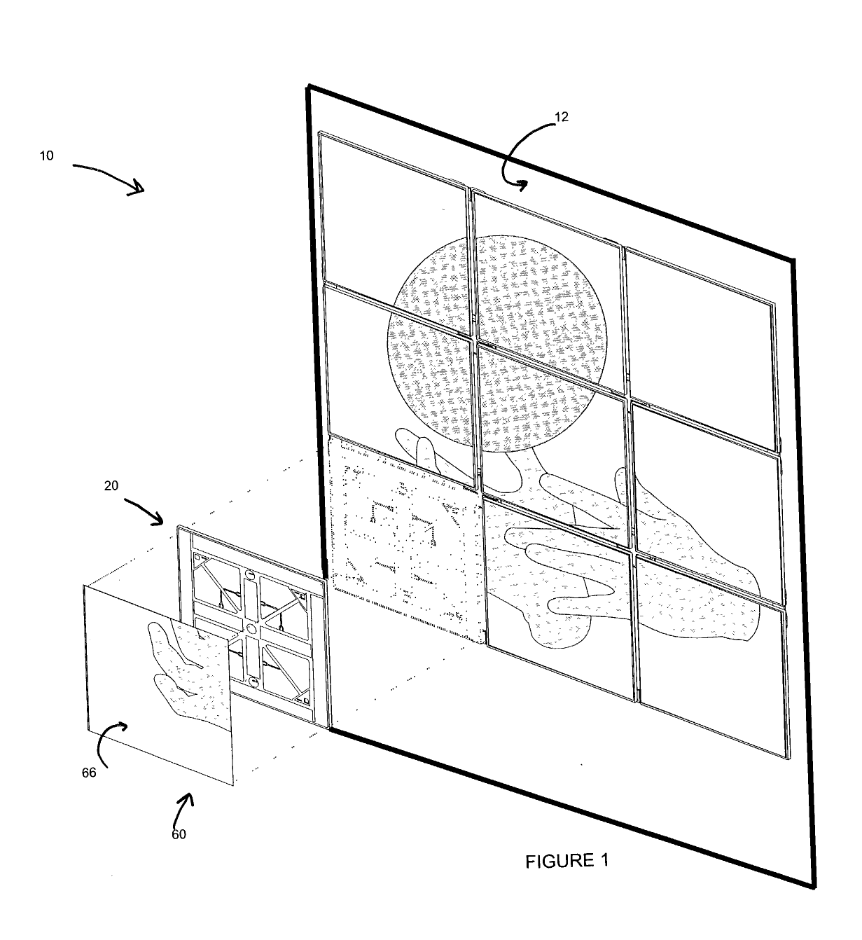

According to an exemplary embodiment shown in FIGS. 1 to 5 display system 10 comprises one or more frames (e.g. a frame system or network, bases, mounting surfaces, mounting structures, support structures, supports etc. shown as frame 20), one or more linking elements or connectors (e.g., fasteners, mounting points, interconnects, brackets, links, etc. shown as link 40), and one or more panels (e.g., sheets, graphics sheets, etc. shown as panel 60).

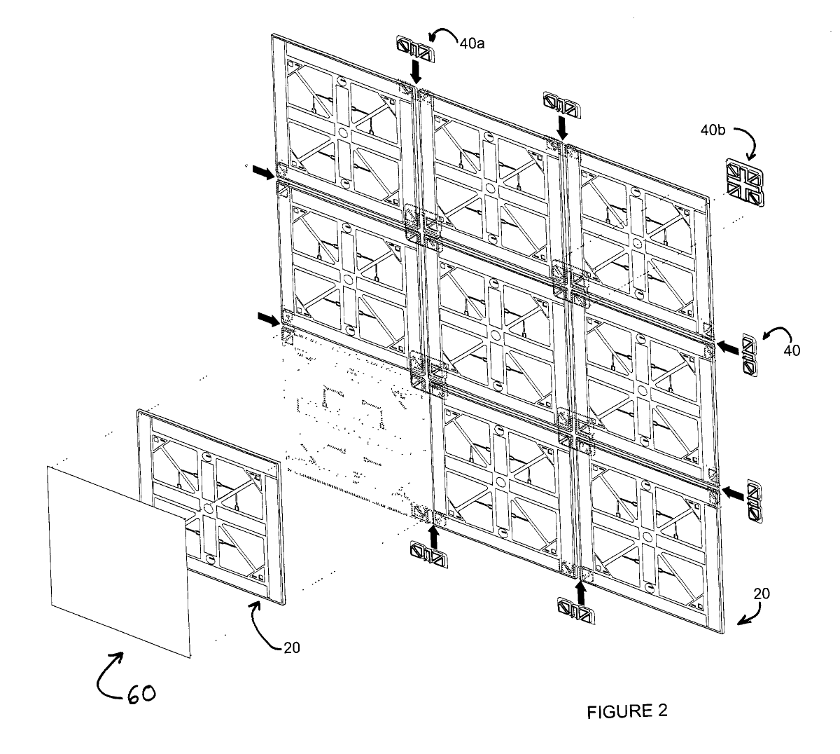

According to a particularly preferred embodiment shown in FIG. 2, frame 20 has a square shape approximately two feet by two feet in size. According to various alternative embodiments, the frame may have a variety of shapes such as rectangular, triangular, diamond, hexagonal, etc. According to further alternative embodiments, the frame may have a variety of sizes.

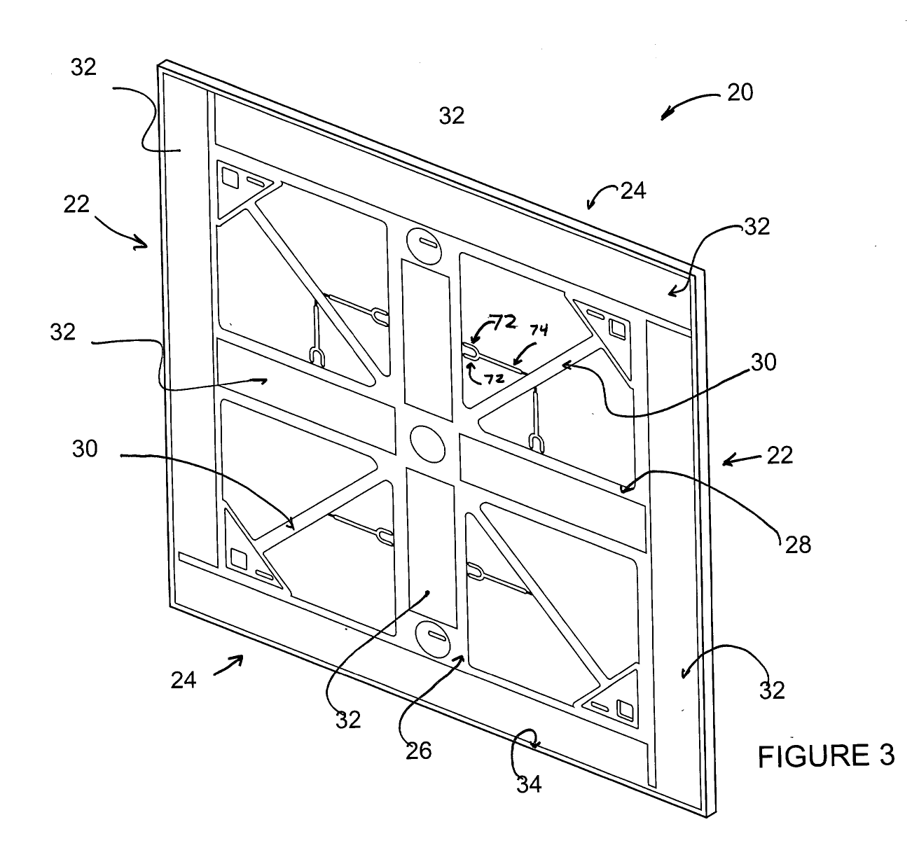

As shown in FIG. 3, frame 20 may be an “open” frame comprised of several members or portions. Vertical members 22 and horizontal members 24 may form the outer boundary of panel 20. Vertical member 26 and horizontal member 28 may form an inner support structure such as a cross shape, etc. Diagonal members 30 may be provided to provide additional strength. The open frame advantageously reduces the amount of material required to manufacture and/or assemble frame 20. According to an alternative embodiment, the frame may have a variety of structural configurations including having a solid body.

According to various exemplary embodiments, the frame may be constructed from a variety of materials, such as aluminum, other metals, metal alloys, plastics, polymers, styrene, vacuum formed plastics, injection molded plastics, composites, etc.

Magnets 32 (e.g., magnetic material, magnetic receptive material, magnetic portions, magnetizable portions, etc.) may be provided on any one or more portions of frame 20. As shown in FIG. 3, magnets 32 are provided on vertical members 22, horizontal members 24, vertical member 26 and horizontal member 28 of frame 20. According to various alternative embodiments, magnets may be provided on various portions, edges, cross-shaped members, diagonal members, other selected areas, or all areas on the frame. According to other alternative embodiments, magnets may be provided on a surface, or below a surface of the frame. Magnets may occupy any space and/or cover any surface area sufficient to provide, in part, support for the graphic. Other lips or edges (e.g. edge 34 on frame 20) may also provide support for the graphic.

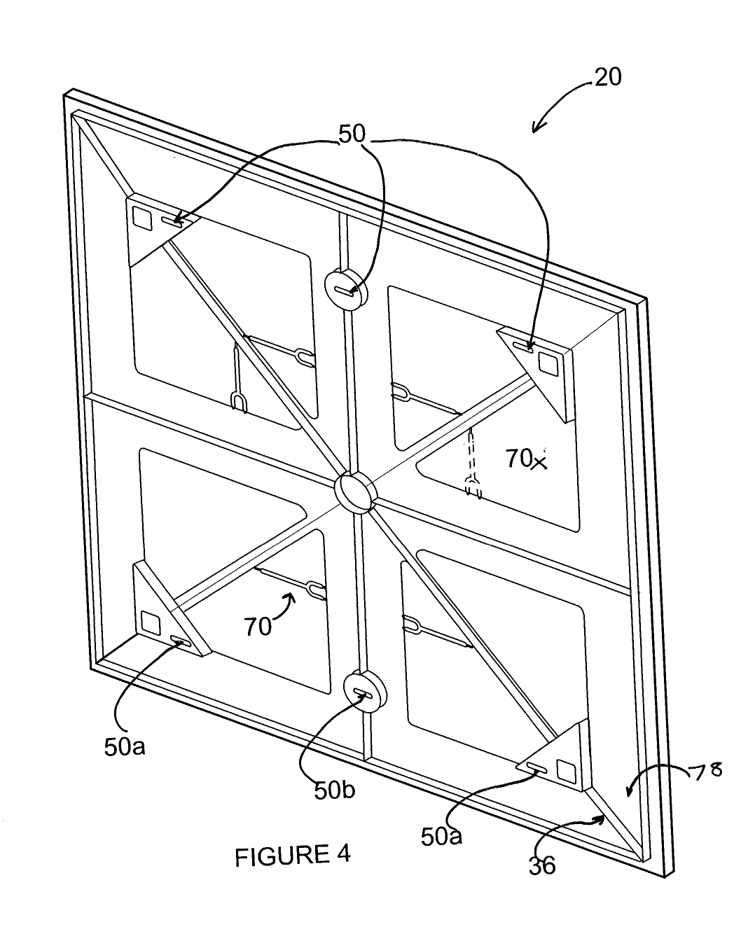

According to a particularly preferred embodiment, frame 20 may be configured to attach to a support surface (such as wall 12) via fasteners (such as screws, bolts, adhesives, etc.) provided through apertures 50. According to a particularly preferred embodiment shown in FIG. 4, six apertures may be provided for mounting frame 20 to the wall. Apertures 50a may be provided at or near corners of frame 20. Apertures 50a may be used in installations onto flat walls. Apertures 50b may be provided on a central vertical axis of frame 20. Apertures 50b may be used in installations of the frame onto curved walls.

As shown in FIG. 4, one or more spacers 70 (e.g. shims) may be provided on frame 20. According to a particularly preferred embodiment, spacers 70 may be molded in during the construction and/or assembly of frame 20. Spacers 70 may be removed or broken off of frame 20 for use while installing frame 20 onto wall 12 (see FIG. 4, spacer 70x). For example, if wall 12 is not flat, or if there would otherwise be gaps between frame 20 and wall 12, spacer 70 may be provided between frame 20 and wall 12 to fill the space or gap. Spacer 70 may further advantageously assist in preventing breakage or fracture of frame 20 while being installed. According to a particularly preferred embodiment, spacer 70 has two prongs 72 and member 74. Prongs 72 may be placed on either side of aperture 50, thereby allowing a fastener to coact with the wall, while still providing a spacer or backer between frame 20 and wall 12. Member 74 may advantageously allow an installer to handle or hold spacer 70 while installing a fastener through aperture 50.

As shown in FIG. 2, mounting or linking elements shown as links 40 are provided between adjacent panels. Link or connector 40 may further be configured to link, space, attach couple, interconnect guide, or position adjacent frames. Link may provide relative positioning between adjacent frames. Link may also be configured to provide gaps or spaces between adjacent panels with controllable tolerances. As shown in FIG. 2, link 40 may be configured to attach two adjacent frames (see link 40a). Link 40 may also be configured to attach four adjacent frames (see link 40b). According to various alternative embodiments, the link may be configured to attach or couple two or three or more adjacent panels.

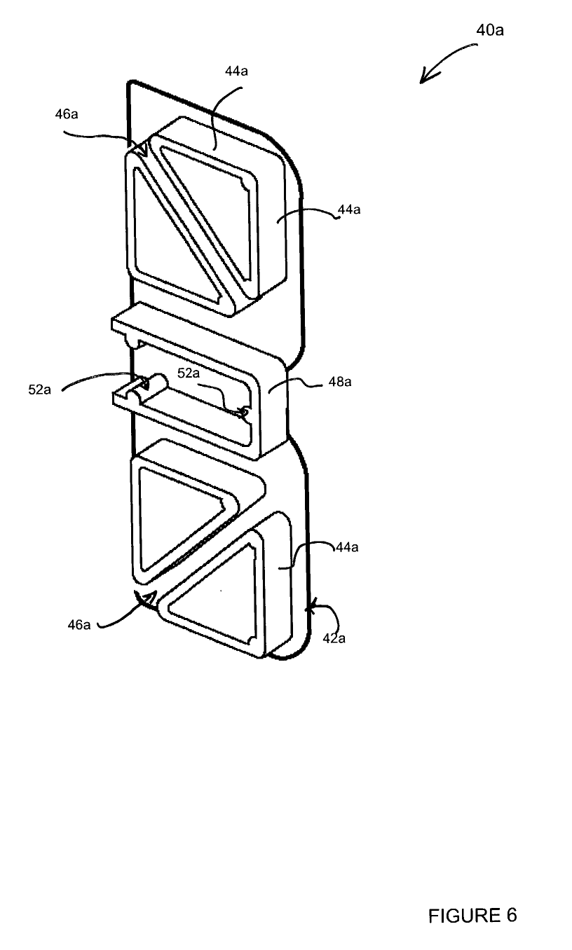

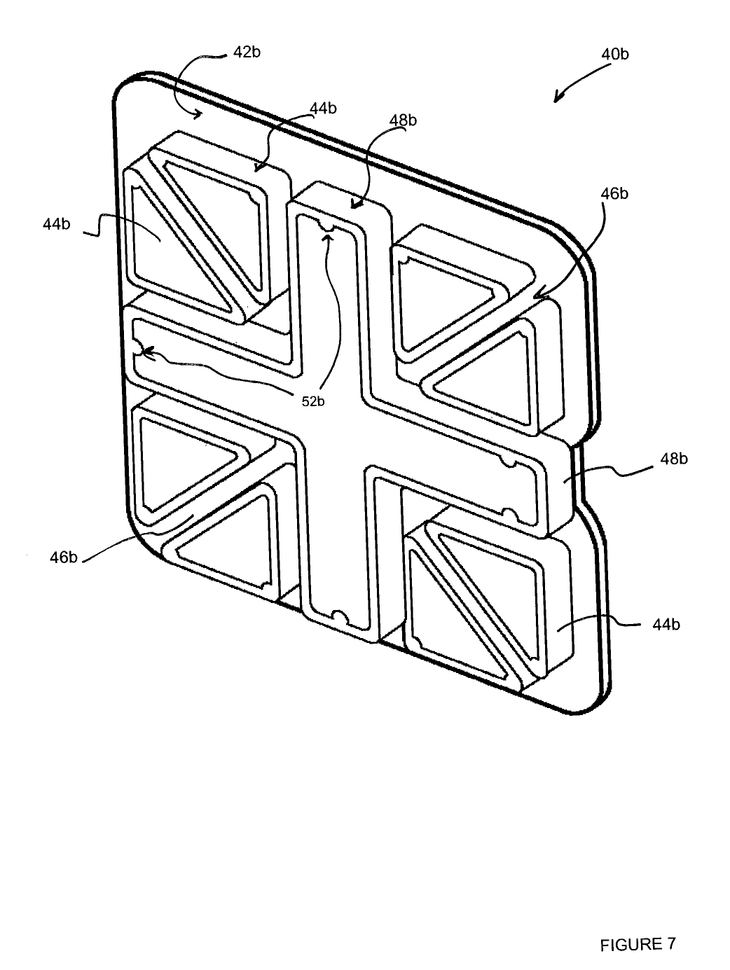

As shown in FIGS. 6 and 7, link 40 comprises a base 42, one or more walls 44, one or more slots 46, and one or more spacer portions 48. Walls 44 may be constructed from resilient or flexible material. As shown in FIG. 6, link 40a is configured to couple two adjacent panels. Walls 44a are provided on base 42a. According to a particularly preferred embodiment, walls 44a form one or more slots 46a. Walls 44a and slots 46a may comprise a connector portion. For example, walls 44a may be configured to be received in a recessed portion on the back of frame 20 (see FIG. 4, portion 78). Slot 46a is configured to receive a raised portion 36 (or rib) provided on a back side of panel 20 (see FIG. 4). Raised portion 36 fits into slot 46a to assist in the proper placement and positioning of panel 20. Spacer portion 48a is configured to form (and thereby fit between) a gap between two adjacent panels. Spacer portion 48a also assists in the proper placement and positioning of panel 20. According to a particularly preferred embodiment, spacer portion 48a has a U-shape. The closed-end of the U-shape may be installed facing outward in an installed position, thereby providing a “finished” edge. Projections 52a may be provided on spacer portion 48a for increased strength or rigidity.

As shown in FIG. 7, link 40b is configured to couple four adjacent panels. Walls 44b are provided on base 42b. According to a particularly preferred embodiment, walls 44b form one or more slots 46b. Slot 46b is configured to receive a raised portion 36 provided on a back side of panel 20. Raised portion 36 fits into slot 46b to assist in the proper placement and positioning of panel 20. Spacer portion 48b is configured to form (and thereby fit between) a gap between the four adjacent panels. Spacer portion 48b also assists in the proper placement and positioning of panel 20. According to a particularly preferred embodiment, spacer portion 48a has a cross shape. Projections 52b may be provided on spacer portion 48b for increased strength or rigidity.

According to other alternative embodiments, the link may have a wide variety of shapes and/or configurations which provide for the proper spacing and/or interconnectivity of adjacent panels. According to an exemplary embodiment, the link and panel coact with an interference fit, press fit, via deformation of the walls, etc. According to another alternative embodiment, the spacer portion may be omitted. According to other alternative embodiments, more or fewer projections (e.g., wall portions) may be provided.

Links 40 may be provided as display system 10 is constructed and/or assembled. According to a particularly preferred embodiment, a vertical line may be provided on wall 12 as a reference line. A first panel 20 may be coupled to wall 12 along the vertical reference line. Links 40 may then be provided in appropriate locations (e.g. corners of panel 20). Additional panels may then be coupled to wall 12, using links 40 for the appropriate spacing and/or placement. As display system 10 is assembled by placing frames 20 on wall 12, links 40 assist in keeping frames 20 in straight lines along wall 12, and ensuring proper placement and alignment of frames 20.

According to an alternative embodiment, the link is configured to be coupled to a wall with one or more fasteners, and the frames are then configured to couple or coact with the link. According to further alternative embodiments, links may be coupled to the wall, and then panels may be provided on the links. According to other alternative embodiment, the link may be configured to be placed along edges and/or corners of the panel.

Link may be constructed and/or assembled from a single body. According to alternative embodiments, the link may be constructed and/or assembled from multiple pieces and/or assemblies. According to a particularly preferred embodiment, links may be constructed and/or assembled from injection molded plastic. According to alternative embodiments, the link may be constructed and/or assembled from a variety of other materials, including polymers, composites, metals, etc.

As shown in FIG. 1, panels 60 (e.g., graphics, sheets, panes, etc.) are provided for use with display system 10. A graphic (e.g., any type of information, text, visual display, visual effect, artwork, photographs, pictures, simulated surface finishes, graphics, etc.) may be provided on a front surface 66 of panel 60. According to a particularly preferred embodiment, the graphic provided on an individual panel is a portion or component of an overall larger image. According to another particularly preferred embodiment, the panel is a portion or component of an overall larger image or graphic. According to an alternative embodiment, a graphic may be provided on an individual panel or by combination of two or more panels. According to another alternative embodiment, the panel may be blank, allow for additional marking or placement of graphics, etc. According to an exemplary embodiment, a graphic may be provided on either an individual panel or in or by some combination of two or more panels.

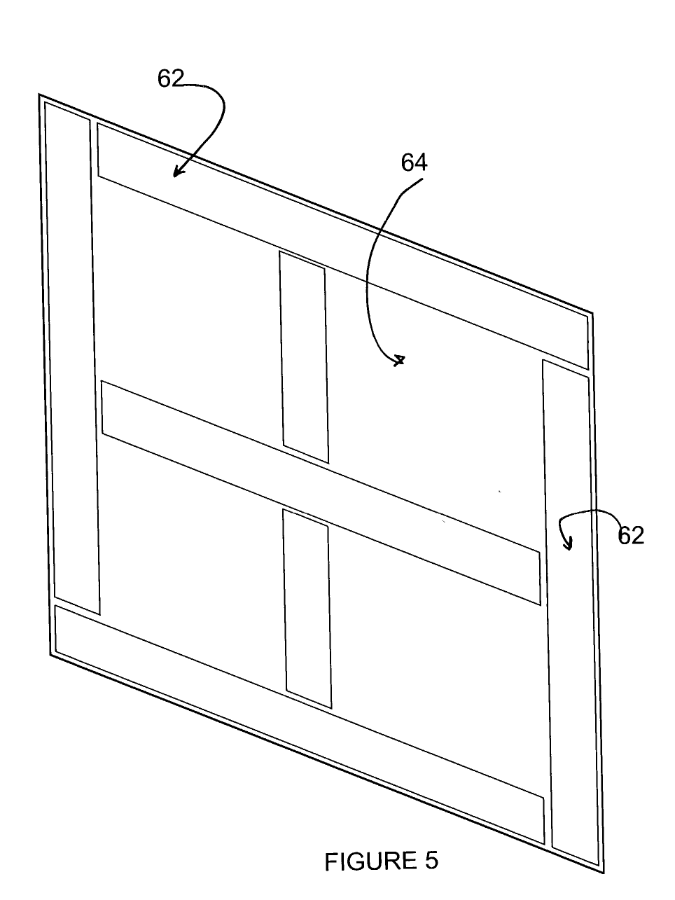

As shown in FIG. 5, magnets 62 (e.g., magnetic material, magnetic receptive material, magnetic portions, magnetizable portions, etc.) are provided on a back surface 64 of panel 60. Magnets 62 co-act with magnets 32 on frame 20 to hold the panel 60 to frame 20.

The interaction of the panels with the frame allows the graphics (and overall graphic) to be easily removed, replaced, added, changed, updated, etc. The removable panels provide levels of reconfigurability, interchangeability, and replaceability. For example, display systems may be used in automotive dealerships for displaying pictures of cars, car models, advertising, etc. Such graphics often need to be updated due to model changes, developments, etc. The overall graphic may be changed as part of a scheduled update or maintenance or altered in conjunction with special events. Display system 10 provides an advantageous way of allowing easy updates of the graphics. Only replacement graphic sheets need to be printed (on a suitable magnetic panel such as paper having a magnetized or magnetizable ink) in order to update the visual effect of the wall. The panels may still be used in the display system.

It should be appreciated that the magnets, magnetic portions, magnetized portions, magnetically receptive materials, etc do not require a certain configuration. These magnetic and/or magnetically receptive materials may be provided in a variety of arrangements, (i.e. a magnet may be placed on the panel, and magnetically receptive materials may be provided on the frame; two magnets may be provided; a magnetized portion may be placed on the frame, and a magnet on the panel, etc.).

According to a particularly preferred embodiment, panels 60 are constructed from eighteen point tag-stock which has been varnished on both sides to assist in preventing warping due to humidity. According to various exemplary embodiments, panels 60 are a paper product having a magnetized or magentizable ink provided on a back surface. According to various alternative embodiments, panels may be constructed from tag-stock, photo paper, styrene, film, paper, plastics, ABS plastic, etc.

The frames and/or panels may be provided with indicia which would aid in the construction of the display system. For example, each panel may be provided with a reference numeral (e.g. A-1, B-4, etc.) which would be indicative of the relative placement of each panel in the display system.

The frames may be attached to an existing wall or similar surface using fasteners such as screws, nails, other mechanical fasteners, adhesives or the like. The frames may be laid out for proper orientation on the wall using a template, showing the placement of the frames, or alternatively, the frames may mounted to the wall by lining up the frames with markings provided on the wall (such as level lines, plumb lines, scribed lines, levels, etc.). A series of frames may be mounted to a wall, making a grid type system of frames onto which panels may be mounted. According to other alternative embodiments, a single panel may be attached to the support structure, with the links providing support/linking the remaining panels together.

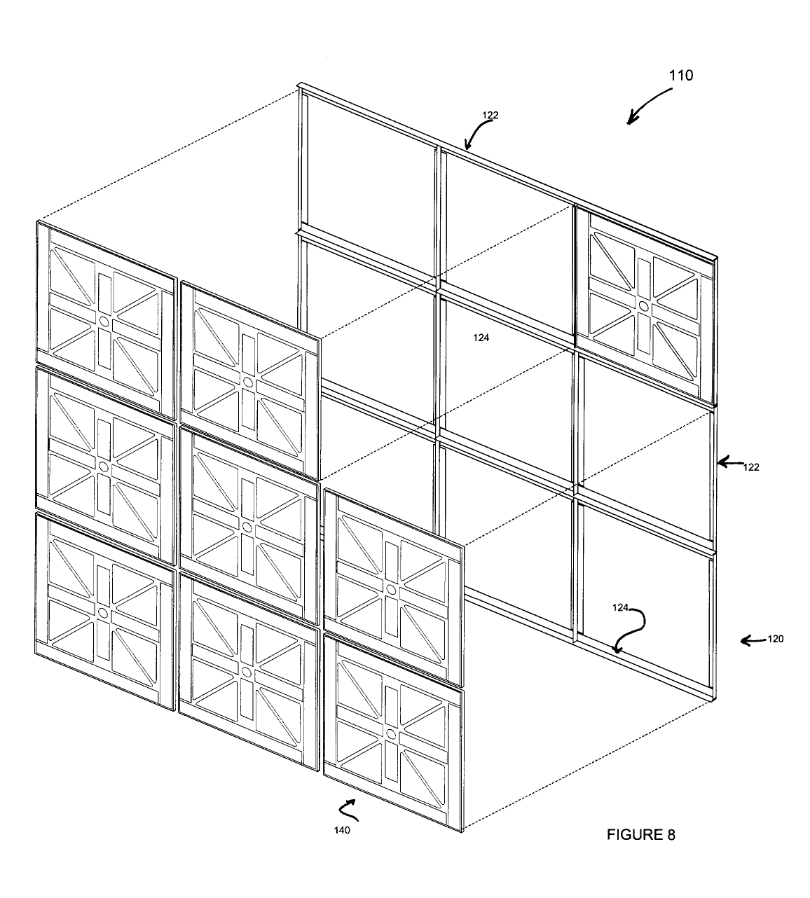

According to another exemplary embodiment shown in FIGS. 8 to 11 display system 110 comprises one or more frames (shown as frame 120), one or more panels (shown as panel 140), and one or more sheets 160 (e.g., graphic sheets, panels similar to panels 40, etc.).

As shown in FIG. 8, one or more frames 120 (e.g., mounting structures, support structures, grids, frames, supports) may be provided for use with display system 110. Frame 120 may be a series or grid assembly of tracks 122 (e.g. rails, extrusions, etc.). Frames 120 may be constructed from a variety of materials, such as extruded aluminum railings, other metals, metal alloys, plastics, composites, etc.

Tracks 122 may be provided in a grid assembly as shown in FIG. 8. The grid size (i.e., the spacing between adjacent tracks) may be a variety of dimensions, however in a particularly preferred embodiment, the grid size is approximately 2 feet by 2 feet.

In an exemplary embodiment, track 122 has a T-shaped cross section, although other shapes may be used.

One or more fasteners 124 may be provided on track 122. According to a particularly preferred embodiment, fastener 124 is a Velcro fastener. According to various alternative embodiments, other coacting elements (e.g., fasteners, attachment mechanisms, Velcro, low bond adhesives, mechanical connectors, clips, magnets, etc.) may be provided on (or within or adjacent to) track 122.

Frames 120 may be mounted to a wall using fasteners (not shown) such as screws, adhesives, bolts, other mechanical fasteners, etc. Frames 120 are laid out in a grid arrangement having vertical and horizontal tracks. The grid arrangement results in a series of individual frames for receiving panels 140.

Panels 140 are dimensioned to be received in a corresponding grid opening (i.e. in an exemplary embodiment, approximately 2 feet by 2 feet, although other sizes may also be used).

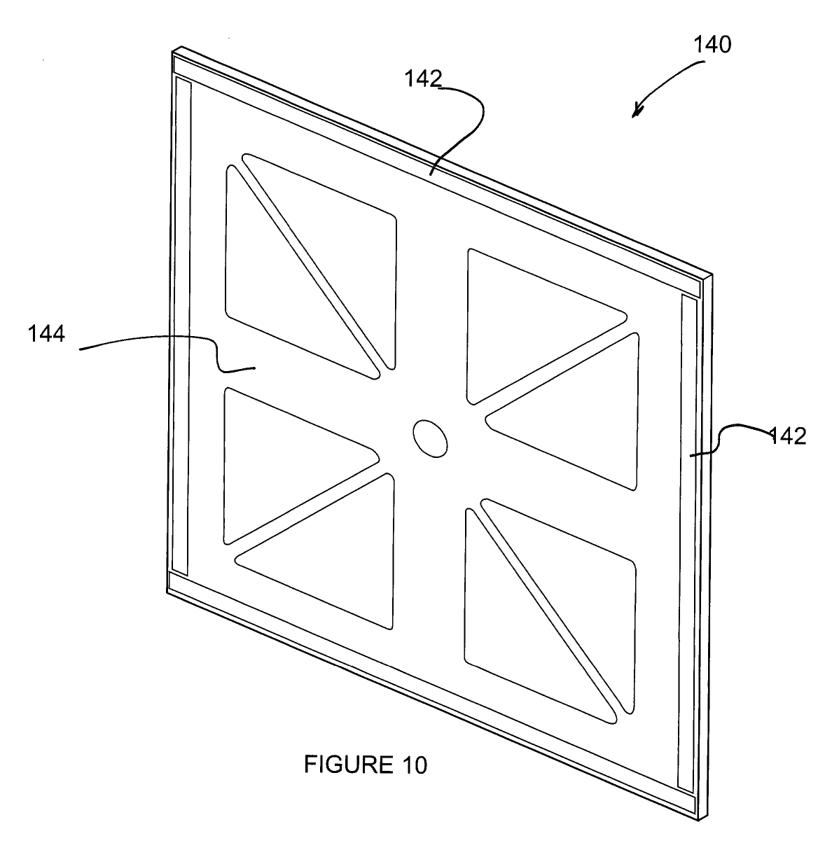

Panels 140 may be provided with fasteners 142 configured to couple or coact with fasteners 124. Fasteners 142 may be provided on a back surface 144 of panel 140 (see FIG. 10.

According to a particularly preferred embodiment, fastener 142 may be a Velcro fastener provided along edges of back surface 144 configured to engage with Velcro fasteners 124 provided on frame 120. According to various alternative embodiments, other coacting elements (e.g., fasteners, attachment mechanisms, Velcro, low bond adhesives, mechanical connectors, clips, magnets, etc.) may be provided on (or within or adjacent to) back surface 144. In a preferred embodiment, the fasteners provides a non-permanent attachment between the panels and frame. A non-permanent attachment is preferable as to allow removal of panels from the display system, although permanent attachment means may be used.

According to various exemplary embodiments, the panels may be constructed from plastics, polymers, Sintra™ material, styrene, vacuum formed plastics, injection molded plastics. An advantageous feature of using plastics is that the material may be provided in a variety of desired or preselected colors. By providing the panel in the desired color removes processing steps which may have been required for edge treatments. Since the panel is formed in the desired color, no edge treatments may be required (e.g. additional coloration steps, processing steps, etc.).

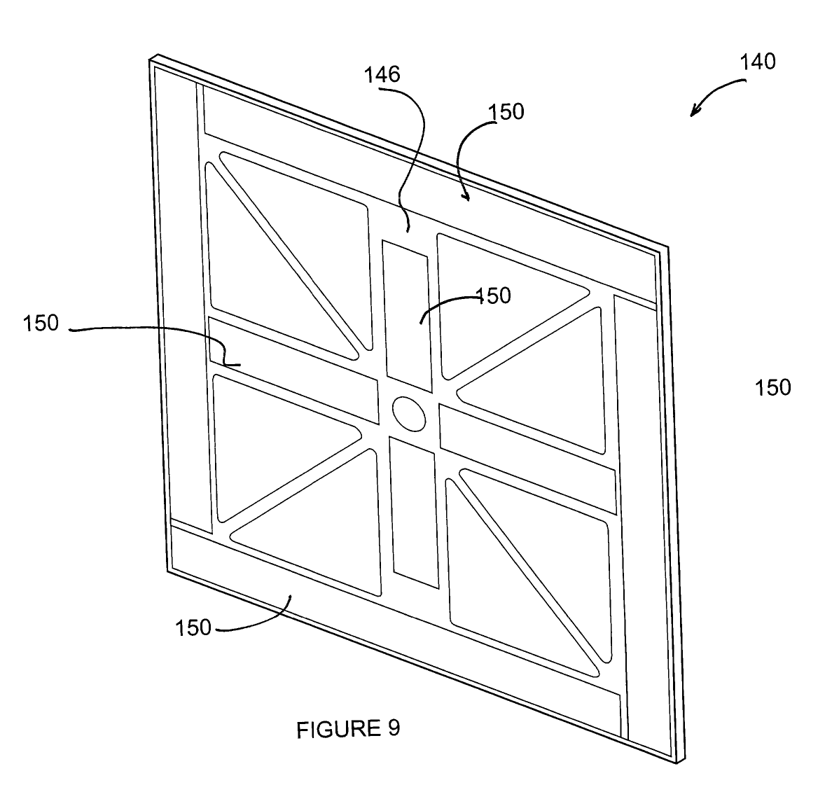

Magnets 150 may be provided on a front surface 146 of panel 140. Magnets 150 may be provided in a grid pattern as shown in FIG. 9, or in a variety of other configurations, including covering the entire surface of front surface 146.

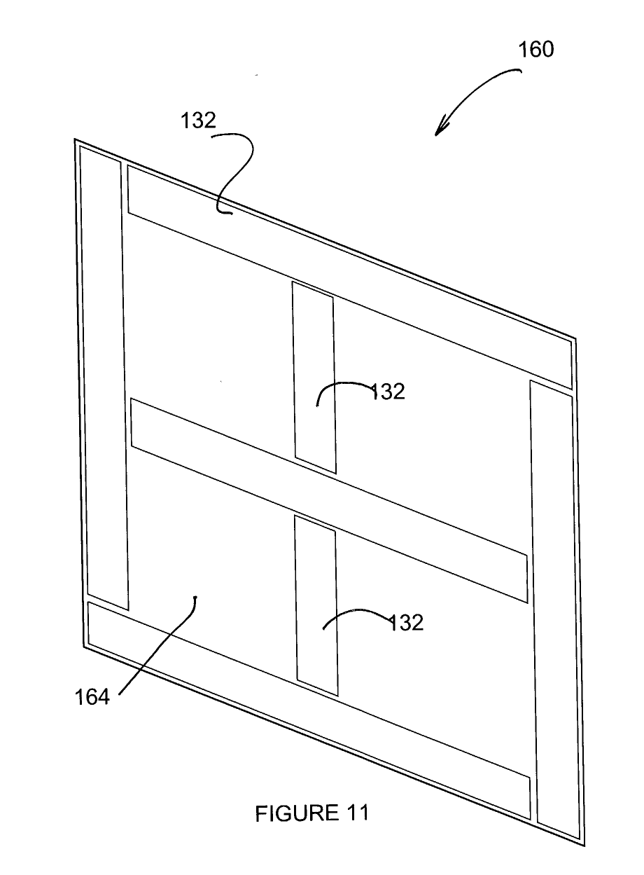

As shown in FIG. 11, one or more sheets 160 may be provided for use with display system 110. Artwork, photographs, pictures, simulated surface finishes, graphics, etc. may be provided on sheets 160. Graphics are provided on or attached to a face of the panels via graphic sheets, graphic panels, etc.

As shown in FIG. 11, sheets 160 may also be provided with magnets 132 (e.g., magnetic material, magnetic receptive material, magnetic portions, magnetizable portions, etc.) on a rear surface 164 of sheet 160. According to a particularly preferred embodiment, magnets 132 are a magnetic receptive ink provide in a pattern configured to overlap with magnets 150. According to one particularly preferred embodiment, sheets 160 magnetically couple to panels 140.

Sheets 160 may be constructed from tag-stock, photo paper, styrene, film, paper, plastics, ABS plastic, etc.

The magnetic interaction of the sheets with the panel allows the graphics (and overall graphic) to be easily removed, replaced, added, changed, updated, etc. For example, display system 110 may be used in automotive dealerships for displaying pictures of cars, car models, advertising, etc. Such graphics often need to be updated due to model changes, developments, etc. The overall graphic may be changed as part of a scheduled update or maintenance or altered in conjunction with special events. Display system 110 provides an advantageous way of allowing easy updates of the graphics. Only new graphic sheets need to be printed (on suitable sheets) in order to update the visual effect of the wall. The panels may still be used in the display system. There is no need to dispose of the panel in order to update the graphic.

Display system 110 is advantageously suited to be used in changing over, upgrading or “retrofitting” a previous grid system. For example, a grid system may have a grid similar to that shown in FIG. 8 with a number of Masonite or similar wood-type-product panels having a visual graphic provided on the panel (typically printed) fastened to the grid with Velcro fasteners. These panels may be removed and replaced with panels 140 and sheets 160. Display system 110 advantageously provides easier changing or updates to the overall graphic. For example, only sheets 160 need to be removed and/or replaced in the event that the overall. Furthermore, sheets 160 may be considerably lighter, easier to store, capable of being folded, rolled, etc., thereby being easier to handle.

It is also important to note that the construction and arrangement of the elements of the display systems as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

What is claimed is:

1. A display system for providing an enlarged graphic on a support surface, the display system comprising:
a first frame configured to be coupled to the support surface;
a first panel configured to be removably coupled to the first frame;
a first graphic component provided on the first panel;
a second frame configured to be coupled to the support surface;
a second panel configured to be removably coupled to the second frame; and
a second graphic component provided on the second panel;
wherein the first graphic and the second graphic components are configured to provide a portion of the enlarged graphic.

2. The display system of claim 1 wherein the first frame and the second frame are coupled to a support surface with fasteners.

3. The display system of claim 2 wherein the fasteners are screws.

4. The display system of claim 1 further comprising indicia provided on the first graphic and the second graphic, wherein the indicia is representative of the position of the first graphic and the second graphic.

5. The display system of claim 1 wherein further comprising magnetic material provided between the first frame and the first panel and provided between the second frame and the second panel.

6. The display system of claim 5 wherein the magnetic material further comprises a magnet.

7. The display system of claim 5 wherein the magnetic material further comprises a magnetizable material.

8. The display system of claim 1 wherein magnetic material is provided on a front surface of the first frame and on a front surface of the second frame.

9. The display system of claim 1 wherein the first frame further comprises at least two horizontal tracks and at least two vertical tracks.

10. The display system of claim 1 wherein the first frame further comprises an injection molded frame.

11. The display system of claim 1 further comprising a link provided between the first frame and the second frame.

12. The display system of claim 1 further comprising:
a third frame configured to be coupled to the support surface;
a third panel configured to be magnetically coupled to the third frame;
a third graphic provided on the third panel;
wherein the first graphic, the second graphic and the third graphic are configured to provide the enlarged graphic.

13. The display system of claim 1 further comprising a spacer coupled to the first frame, the space being configured to be selectively removed from the frame.

14. The display system of claim 13 wherein the spacer further comprises two prongs.

15. A method of providing a graphic using at least two panels, each panel having a portion of the graphic provided on a surface of the panel, the graphic to be provided on a support surface, the method comprising:
providing at least two frames on a support surface;
providing at least two panels configured to be magnetically coupled to the at least two frames;
wherein each portion of the graphic provided on the surface of the at least two panels comprises a portion of the graphic.

16. The method of claim 15 further comprising:
providing a third frame on the support surface;
providing a third panel configured to be magnetically coupled to the third frame;
wherein each portion of the graphic provided on the panels comprises a portion of the graphic.

17. The method of claim 15 further comprising providing indicia on the at least two panels, the indicia being configured to provide information on the relative placement of the at least two panels.

18. A display system comprising:
a first frame;
a first panel configured to be selectively attached and removed from the first frame;
a first sheet; and
a magnetic material provided between the first sheet and the first panel;
wherein the first sheet is configured to be selectively attached and removed from the first panel.

19. The display system of claim 18 further comprising a fastener provided between the frame and the panel.

20. The display system of claim 19 wherein the fastener is a Velcro fastener.

21. The display system of claim 19 wherein the fastener provided between the first frame and the first panel is magnetic material.

22. The display system of claim 18 further comprising:
a second frame;
a second panel configured to be selectively attached and removed from the second frame;
a second sheet; and
magnetic material provided between the second sheet and the second panel;
wherein the first sheet and the second sheet comprise a single image.

23. A method of repairing a display system, the display system having at least one frame and at least one panel connected to the at least one frame with a fastener, the method comprising:
removing the at least one panel;
providing a new panel in the frame, wherein the new panel further comprises:
a fastener configure to coact with the fastener of the frame, and
a sheet magnetically coupled to the new panel.

24. The method of claim 23 wherein a graphic is provided on the sheet.

25. The method of claim 23 wherein the fastener is a Velcro fastener.

26. A method of updating an enlarged graphic, the enlarged graphic being comprised of a plurality of individual sheets magnetically coupled to a plurality of individual bases, the method comprising:
removing the plurality of individual sheets from the plurality of individual bases;
providing a plurality of new individual sheets configured to magnetically couple to the plurality of individual bases.

27. A display system for providing a graphic on a support surface comprising:
a first frame coupled to the support surface;
a first panel configured to be removably coupled to the first frame;
a first graphic component provided on the first panel;
a second frame provided adjacent the first frame;
a second panel configured to be removably coupled to the second frame; and
a second graphic component provided on the second panel; and
a link provided between the first frame and the second frame, wherein the link is configured to interconnect the first frame and the second frame.

28. The display system of claim 27 wherein the link comprises a connector.

29. The display system of claim 28 wherein the connector comprises a connector portion.

30. The display system of claim 27 wherein the link comprises a spacer.

31. The display system of claim 27 wherein the link comprises a first slot configured to coact with the first frame, and a second slot configured to coact with the second frame.

32. The display system of claim 27 wherein the link is configured to interconnect a corner of the first frame with a corner of the second frame.

33. The display system of claim 27 further comprising:
a third frame provided adjacent the first frame; and
a fourth frame provided adjacent the first frame;
wherein the link is configured to interconnect the first frame, the second frame, the third frame and the fourth frame.

34. The display system of claim 27 further comprising:
a third frame provided adjacent the first frame; and
a fourth frame provided adjacent the first frame;
wherein the link is configured to provide for the spacing the first frame, the second frame, the third frame and the fourth frame.
